(19) United States
(12) Patent Application Publication
(10) Pub. No.: US 2024/0430697 A1
(43) Pub. Date: Dec. 26, 2024

(54) DIGITAL TWIN-BASED INTERFERENCE REDUCTION SYSTEM AND METHOD IN LOCAL AUTONOMOUS NETWORKS WITH DENSE ACCESS POINTS

(71) Applicant: BTS KURUMSAL BILISIM TEKNOLOJILERI ANONIM SIRKETI, Istanbul (TR)

(72) Inventors: Elif AK, Istanbul (TR); Khayal HUSEYNOV, Istanbul (TR); Berk CANBERK, Istanbul (TR); Özgür PALANTÖKEN, Istanbul (TR); Gökhan YURDAKUL, Istanbul (TR)

(21) Appl. No.: 18/294,932

(22) PCT Filed: Nov. 2, 2022
(86) PCT No.: PCT/TR2022/051224

§ 371 Date: Feb. 2, 2024

(30) Foreign Application Priority Data
Sep. 15, 2022 (TR) 2022/014285

(51) Int. Cl. H04W 16/22; G06N 3/092; H04W 16/18

(52) U.S. Cl. CPC H04W 16/22; G06N 3/092; H04W 16/18

(57) ABSTRACT

To reduce the negative impact of interference observed in wireless networks and amplified with dense access point deployments, a system and method are disclosed for finding and adjusting Access Points' transmit power configuration that most reduce the impact of the interference by employing an exhaustive search enabled by Reinforcement Learning.

### TECHNICAL FIELD

To reduce the negative impact of interference observed in wireless networks and amplified with dense access point deployments, the invention relates to a system and method for finding and adjusting Access Points' transmit power configuration that most reduce the impact of the interference by employing an exhaustive search enabled by Reinforcement Learning instead of using myopic solutions.

### BACKGROUND ART

Transmit Power Control (TPC), which is one of the Coordinated Spatial Reuse (CSR) techniques for Multi Access Point coordination, has been discussed in the literature both within the scope of the WiFi standard and in other solutions.

The solutions implemented within the scope of the standard are rule-based and the data in the physical layer is collected via the wireless medium which may cause an additional burden to the communication. The rule-based calculations of the transmission powers of the access points in the standard and found in other solutions are done on the access points. As such, these solutions are challenged by limited hardware resources of the access points such as computing and memory. Although such algorithms may perform well under predefined conditions, they may not adapt well to the dynamic nature of wireless networks.

Another solution is a central controller that adjusts the transmission power and channel selection of the access points based on the Q-Learning algorithm. The state of the network is defined using the two-dimensional locations collected from the devices. However, this data collection process again requires additional communication over the wireless medium, which may cause an overhead. Also, calculations deduced from locations alone may not properly represent the problem. While the proposed solution produced the desired results, using an offline learning strategy may have counteracted achieving lower interference.

Access point and controller-based solutions presented in the literature do not have the infrastructure suitable for Artificial Intelligence learning and do not fully adopt real-time monitoring, bidirectional data, and control flows.

Some of the available academic resources are:
1. Zhong Z, Kulkami P, Cao F, Fan Z, Armour S. Issues and challenges in dense WiFi networks. In: 2015 International Wireless Communications and Mobile Computing Conference (IWCMC) [Internet]. IEEE; doi: 10.1109/IWCMC.2015.7289210
2. Fahim M, Sharma V, Cao T-V, Canberk B, Duong TQ. Machine Learning-Based Digital Twin for Predictive Modeling in Wind Turbines. IEEE Access [Internet]. 2022; 10:14184-94. doi: 10.1109/access.2022.3147602
3. Do-Duy T, Van Huynh D, Dobre O A, Canberk B, Duong T Q. Digital Twin-Aided Intelligent Offloading with Edge Selection in Mobile Edge Computing. IEEE Wireless Communication Letters [Internet]. 2022; 11:806-10. doi: 10.1109/lwc.2022.3146207
4. Khorov E, Kiryanov A, Lyakhov A, Bianchi G. A Tutorial on IEEE 802.11ax High Efficiency WLANs. IEEE Communications Surveys & Tutorials [Internet]. 2018; 21(1):197-216. doi: 10.1109/COMST.2018.2871099
5. Deng C, Fang X, Han X, Wang X, Yan L, He R, et al. IEEE 802.11be Wi-Fi 7: New Challenges and Opportunities. IEEE Communications Surveys & Tutorials [Internet]. 2020; 22(4):2136-6. doi: 10.1109/COMST.2020.3012715
6. Aio K. Coordinated Spatial Reuse Performance Analysis [Internet]. 2019. Available from: https://mentor.ieee.org/802.11/dcn/19/11-19-1534-01-00be-coordinated-spatial-reuse-performance-analysis.pptx
7. Wang J J-M, Ku C-T, Bajko G, Anwyl G A, Feng S, Liu J, et al. MULTI-ACCESS POINT COORDINATED SPATIAL REUSE PROTOCOL AND ALGORITHM [Internet]. European Patent. 3 809 735 A1, 2021. Available from: https://data.epo.org/publication-server/document?iDocld=6519834
8. Ak E., Canberk B. FSC: Two-Scale Al-Driven Fair Sensitivity Control for 802.11ax Networks. In: GLOBECOM 2020-2020 IEEE Global Communications Conference [Internet]. 2020. doi: 10.1109/GLOBECOM42002.2020.9322153
9. He C, Hu Y, Chen Y, Fan X, Li H, Zeng B. MUcast: Linear Uncoded Multiuser Video Streaming With Channel Assignment and Power Allocation Optimization. IEEE Transactions on Circuits and Systems for Video Technology [Internet]. 2019; 30(4):1136-46. doi: 10.1109/TCSVT.2019.2897649
10. Zhang Y, Jiang C, Han Z, Yu S, Yuan J. Interference-Aware Coordinated Power Allocation in Autonomous Wi-Fi Environment IEEE Access [Internet]. 2016; 4:3489-00. doi: 10.1109/ACCESS.2016.2585581
11. Zhao G, Li Y, Xu C, Han Z, Xing Y, Yu S. Joint Power Control and Channel Allocation for Interference Mitigation Based on Reinforcement Learning. IEEE Access [Internet]. 2019; 7:177254-65. doi: 10.1109/ACCESS.2019.2937438
12. Jones W, Eddie Wilson R, Doufexi A, Sooriyabandara M. A Pragmatic Approach to Clear Channel Assessment Threshold Adaptation and Transmission Power Control for Performance Gain in CSMA/CA WLANs. IEEE Transactions on Mobile Computing [Internet]. 2019; 19(2):262-75. doi: 10.1109/TMC.2019.2892713
13. Zhou C, Yang H, Duan X, Lopez D, Pastor A, Wu Q, et al. Digital Twin Network: Concepts and Reference Architecture [Internet]. IETF Datatracker. 2022 [cited 2022 Apr. 24]. Available from: https://datatracker.ietf.org/doc/draft-irtf-nmrg-network-digital-twin-arch/00/
14. Wu Y, Zhang K, Zhang Y. Digital Twin Networks: A Survey. IEEE Internet of Things Journal [Internet]. 2021; 8(18):13789-804. doi: 10.1109/JIOT.2021.3079510
15. Barricelli B R, Casiraghi E, Fogli D. A Survey on Digital Twin: Definitions, Characteristics, Applications, and Design Implications. IEEE Access [Internet]. 167653-167671; 7. doi: 10.1109/ACCESS.2019.2953499
16. Microsoft. DTDL models—Azure Digital Twins [Internet]. Microsoft Docs. 2022 [cited 2022 Apr. 24]. Available from: https://docs.microsoftcom/en-us/azure/digital-twins/concepts-models
17. ns-3|a discrete-event network simulator for internet systems [Internet]. [cited 2022 May 6]. Available from: https://www.nsnam.org/

As a result, due to the negative aspects described above and the inadequacy of the existing solutions on the subject, it was necessary to make an improvement in the relevant technical field.

### PURPOSE OF THE INVENTION

Unlike the structures used in the current art, the invention aims to present a structure with state-of-the-art technical features that bring a new perspective to this field.

The primary aim of the invention is to put forth a system and method to reduce the interference that occurs in the wireless medium and is amplified by dense access point deployments by selecting the probability that results in the least possible interference created by access points on devices.

The system and method, which is the subject of the invention, obtain the interference-related data by recording the packets detected by the access points, without creating additional communication burden on the wireless environment, thanks to the agent program deployed at each access point in the physical layer of the proposed architecture.

The invention uses a Digital Twin of the WiFi network called Digital Twin WiFi Network (DTWN), which provides real-time monitoring and management capabilities. The frequency of coupling with the Physical Layer is also examined in the invention. Moreover, this Digital Twin Network Layer transmits data to the Brain Layer where it can perform computation.

The Brain Layer which is situated in the cloud adapts to the dynamic nature of the physical network by continuously interacting with the digital network to realize Q-Learning-based transmission power control. By performing the calculation in the cloud instead of the access points, the resource problem is also avoided.

In order to fulfill the above-mentioned objectives, the invention aims to reduce the negative impact on performance caused by the interference problem in wireless networks and amplified by dense access point positioning, by being a system that chooses the possibility that provides the solution that reduces the impact of the interference created by the access points on the devices the most, by using reinforcement learning and performing an extensive search process, and its feature is;
The physical network that communicates with stations,
Station consisting of fixed or portable devices capable of using certain protocols,
Access point consisting of a network hardware device that connects other Wi-Fi devices to a wired network,
Agent application that records packets detected by the access point and communicates with the controller,
Cloud consisting of flexible online computing resources shared among users and scalable at any time,
Controller that performs all the procedures and modules in the system,
The digital twin network layer, which creates an interference-based representation of the physical network layer,
Southbound interface for communication between the physical network layer and the digital twin layer,
Digital twin collection which consists of digital twins,
Digital twin which is a realistic virtual representation of the physical entity,
Northbound interface that provides communication between the digital twin layer and the brain layer,
The brain layer where applications that can run effectively on a digital twin network platform and make requests which need to be handled by the digital twin network are deployed to implement traditional or innovative network operations with low cost and less service impact on real networks,
Admission control module that decides whether procedures need to be repeated,
Topology extraction module that extracts the network topology by mapping the objects,
Q-Learning based transmit power control agent which tries to find the tuning that reduces interference,
Network state generation module that generates network state using requirements table, performance table, and topology,
Reward function module that generates rewards by looking at the difference between network states,
Reinforcement learning agent that updates the Q Table and determines the action according to the greedy rate.

The structural and characteristic features of the invention and all its advantages will be understood more clearly thanks to the figures given below and the detailed explanation written with reference to these figures. Therefore, the evaluation should be made by taking these figures and detailed explanations into consideration.

### FIGURES TO HELP UNDERSTAND THE INVENTION

FIG. 1, is the representation of the physical layer.

FIG. 2, is the representation of the digital twin network layer.

FIG. 3, is the representation of the brain layer.

FIG. 4, is the schematic representation of the method which is the subject of the invention.

FIG. 5, is the general representation of the system which is the subject to the invention.

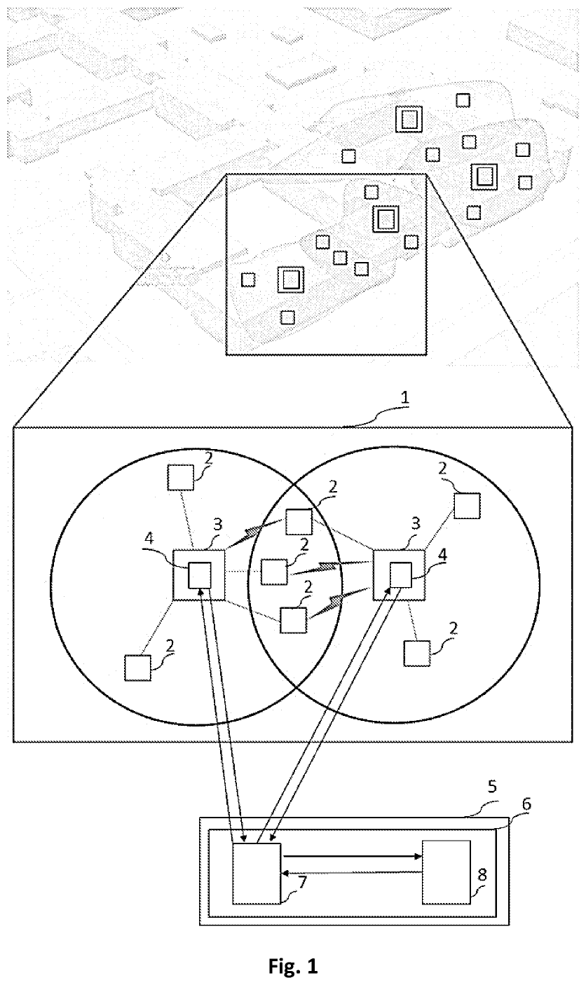

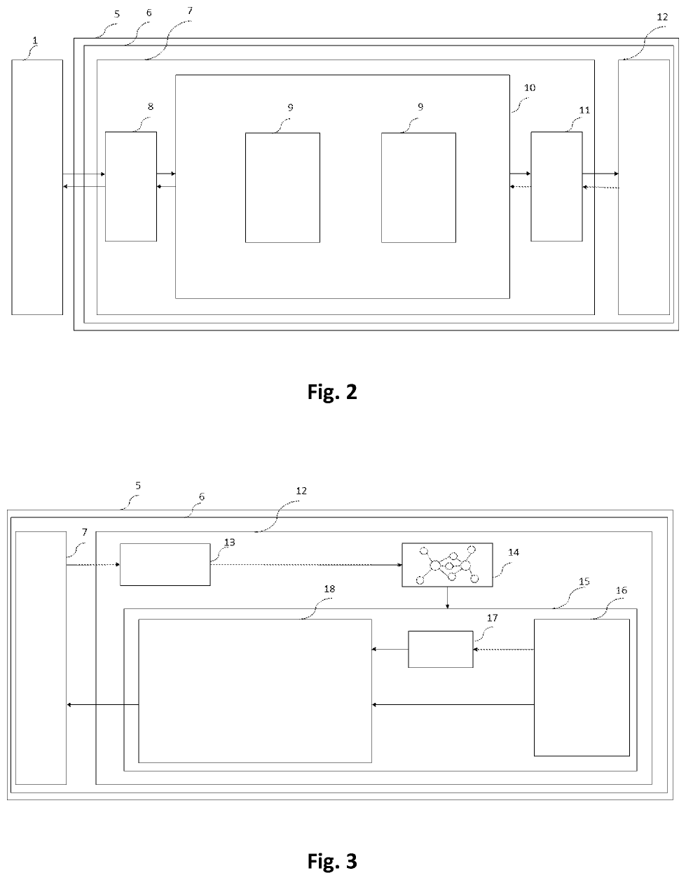

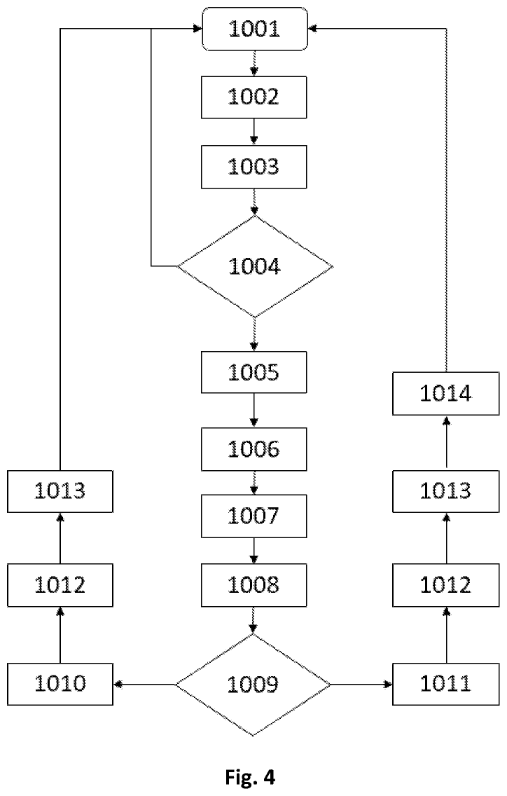

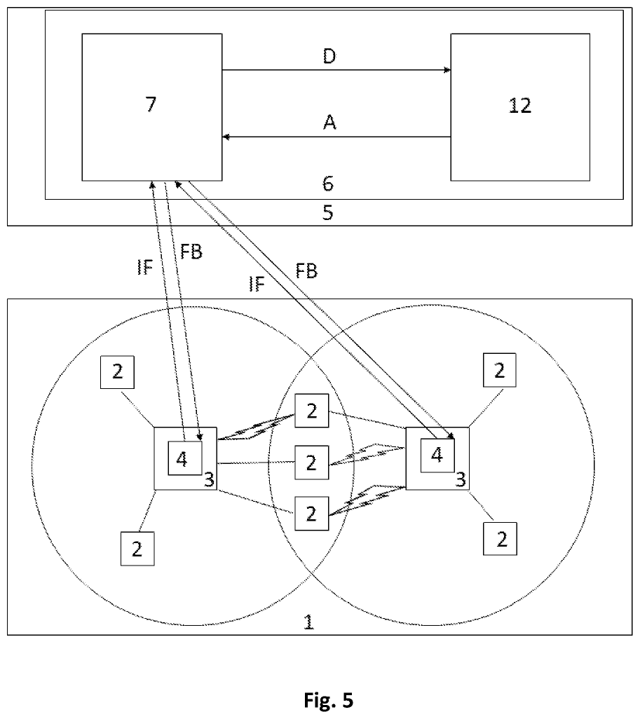

Drawings are not necessarily to scale and details not necessary for understanding the present invention may be omitted. Furthermore, elements that are at least substantially identical or have at least substantially identical functions are denoted by the same number.

### DESCRIPTION OF EMBODIMENTS

1. Physical Network
2. Station
3. Access Point
4. Agent program
5. Cloud
6. Controller
7. Digital Twin Network Layer
8. Southbound Interface
9. Digital Twin Collection
10. Digital Twin
11. Northbound Interface
12. Brain Layer
13. Access Control Module
14. Topology Extraction Module
15. Q-Learning based Transmit Power Control Agent
16. Network State Generation Module
17. Reward Function Module
18. Reinforcement Learning Agent
D. Digital Twin data
A. Action
IF. Information flow
FB. Feedback

### DETAILED DESCRIPTION OF THE INVENTION

In this detailed description, preferred embodiments of the invention are explained only for a better understanding of the subject and without any limiting effect.

To reduce the negative impact of interference observed in wireless networks and amplified with dense access point deployments, the invention relates to a system and method for finding and adjusting Access Points' transmit power configuration that most reduces the impact of the interference by employing an exhaustive search enabled by Reinforcement Learning.

The functions of the elements used in the system subject to the invention are as follows:

The physical network (1) is the physical network through which users are communicating.

Station (2) is a fixed or portable device capable of using the 802.11 protocol.

The access point (3) is a network hardware device that connects other Wi-Fi devices to a wired network.

The agent application (4) is the application that records the packets detected by the access point (3) and communicates with the controller (6).

Cloud (5) is a flexible online computing resource that is shared among users and can be scaled at any time.

The controller (6) is the structure that performs all the procedures and modules in the system that is the subject of the invention.

The digital twin network layer (7) is the interference-based representation of the physical network (1) layer.

The southbound interface (8) is the interface that provides communication between the physical network (1) layer and the digital twin layer (7).

The digital twin collection (9) is the unit in which the digital twins (10) are located.

The digital twin (10) is a realistic virtual representation of the physical entity.

The northbound interface (11) is the interface that provides communication between the digital twin (10) layer and the brain layer (12).

The brain layer (12) is the layer where applications are deployed that can effectively run on a digital twin network platform and make requests that need to be handled by the digital twin network to implement traditional or innovative network operations with low cost and less service impact on real networks.

The access control module (13) is the module that decides whether the procedures need to be repeated or not.

The topology extraction module (14) is the module that extracts the network topology by extracting mapping objects.

The Q-Learning based transmit power control agent (15) is the agent that seeks to find the tuning that reduces interference.

The network state generation module (16) is the module that creates the network state using the requirement table, performance table, and topology.

The reward function module (17) is the module that creates the reward by looking at the difference between the network states.

Reinforcement learning agent (18) is a reinforcement learning agent that updates the Q Table and determines action according to the greedy rate.

The working principle of the system, which is the subject of the invention, is as follows.

Agent applications (4) deployed on the access point (3) in the physical network (1) record the sensed packets alongside with received strength (dBm) and timestamp of packets coming from stations that can be connected or not connected to the sensing access point and periodically transmit the logs to the digital twin network layer (7) which resides in the controller (6) in the cloud (5) according to the twinning frequency f. In the sent data, there is also information about the configuration of the access point (3), the stations (2), and the traffic they have created.

The southbound interface (8) located in the digital twin network layer (7) updates, creates new ones and disconnects the digital twins (10) that have been disconnected from the network in the digital twin collection (9) according to the data it receives. After this process, the digital twin network layer (7) transmits its topology, namely Gₜ, to the brain layer (12) via the northbound interface (11).

If the access control module (13) detects that a new station (2) has entered the network, it starts the optimal tuning search process begins in the brain layer (12). The topology extraction module (14) of the brain layer (12) extracts the topology by separating signal and interference type graph edges so that a reinforcement learning agent (18) can be processed. The network state generation module (16) inside the Q-Learning based transmission power control agent (15) creates the system state with Gt νe φ coming from the digital twin network layer (7). While creating the system state, stations (2) are divided into performance classes according to the φ value. The reinforcement learning agent (18) determines a value θ between 0-30 dBm in action set A. The reward calculation is made by the reward function module (17) by looking at the difference between the system states after each applied action. It is assumed that the topology of the network does not change while the actions are being implemented. For this reason, the decision is made with the logic that the change in the performance classes of the stations is related to the interference value. To achieve the desired balance in the network, the calculated reward is multiplied by the reward factor A which is predetermined according to the state of the network.

The Q table is updated using the formula that includes the calculated reward rₜ, learning rate α, and discount factor γ. Reinforcement learning algorithms work by choosing between two concepts. In the concept of exploration, action is chosen randomly. In the concept of exploitation, the action that promises the least interference in the table is selected. Whether the action uses the concepts of exploration or exploitation is chosen randomly according to the greedy ratio ϵ.

The selected action is applied to the digital twin network layer (7) via the northbound interface (11). The digital twin network layer (7) transmits the action to the physical network (1) with the feedback flow of the southbound interface (8). If the action is to do nothing, the optimal solution has been reached and the process is terminated. If not, the access control module (13) continues the system loop until the optimal solution is found.

The procedures performed in the system which is the subject of the invention are as follows:
The agent application (4) deployed on the access point (3) sends the data about the stations (2) it collects to the digital twin network layer (7) inside the controller (6) which resides in the cloud (5) with a predetermined twinning frequency (1001),
The northbound interface (11) receives the data and updates the digital twins (10) in the digital twin collection (9) (1002),
Transmitting the current state of the digital twin network layer (7) to the brain layer (12) (1003),
If it is detected that a new station (2) has entered the network, an optimal tuning search process starts in the brain layer (12) (1004),
Extraction of the topology so that brain layer (7) can process (1005),
Q-Learning based transmission power control agent (15) generates the system state with the data coming from the digital twin network layer (7) by means of the network state generation module (16) (1006)
After each action is applied, the reward calculation is done by the reward function module (17) (1007),
Updating the Q table in the reinforcement learning agent (18) with the calculated reward (1008),
Reinforcement learning agent (18) uses the concept of exploration or exploitation according to the greedy rate (1009),
Random action selection in exploration concept (1010),
Selecting the action that promises the least interference in the table in the concept of exploitation (1011),
Application of the selected action to the digital twin network layer (7) by the northbound interface (11) (1012),
The digital twin network layer (7) transmits the feedback flow to the physical layer via the southbound interface (8) (1013),
If the action is to “do nothing”, it is understood that the optimal solution has been reached and the process is terminated (1014).

### Problem Formulation

In the invention, the WiFi network is defined as a non-directional weighted graph G=(V, E, w). Here V is the vertex set. In this set, V_{c} denotes the stations and VAP denotes the access points (3). E in the graph is an edge array corresponding to the signal arriving at the station from an access point (3). In this array, the edges formed between Vc and VAP are divided into two groups as signal (Eₛ) and interference (Eᵢ).

The quality of wireless communication is measured by a signal-to-interference-plus-noise ratio (SINR). Therefore, it is assumed that SINR can represent users' service quality and thus performance. However, in this invention, instead of measuring on the station side, a signal-to-interference indicator is defined using the G graph.

### Signal-to-Interference Indicator (φ)

Vc is calculated for station vertices. A station vertex Vc forms the edge with m different access points (3), which are APᵢ∈V_{AP}. One of these edges must be of signal type and is indicated in the formula as APₘ.

$$ϕ = {w}_{m} - 10 {log}_{10} {\sum }_{i = 1}^{m - 1} {10}^{{w}_{i} / 10}$$

The w value in decibels indicates the weight of the e=(APi, client) edge. To get the ratio whole interference signal type is subtracted from the weight of the edge. When it comes to the total interference, the weights are summed up after converting their unit from dBm into mW. Then the total value is converted back to dBm. If there is no interference type edge, the interference is calculated as thermal sound power, i.e. −100 dBm.

### Requirement Classes

Variable φ values provide our understanding of the performance of the vertex. It depends on the traffic characteristics of the client. Therefore, it is necessary to determine how low a value is too low. For this reason, the requirement classes shown in the table were created. Thanks to the analysis made in the digital twin network layer (7), the stations (2) are divided into these requirement classes.

| Requirement Class | Interval |
|---|---|
| A | ϕ > 35 dB |
| B | 35 dB > ϕ > 25 dB |
| C | ϕ < 25 dB |

The level of performance degradation is generally due to the interference of the communication power of access points (3) on the stations. The communication power of the access points (3) is indicated as θ_{APi}. The configurations of all access points (3) are indicated as follows. The m value here is the number of access points (3) in the network.

$${Θ}^{( t )} = [ {θ}_{{AP}_{0}}^{( t )} , {θ}_{{AP}_{1}}^{( t )} , … , {θ}_{{AP}_{m}}^{( t )} ]$$

The goal is to find the optimal ⊖ (t) station vector with a sufficient level of φ.

### Brain Layer (12)

In this layer, transmission power adjustment of the access points (3) is made to prevent interference. All the following modules are located inside the brain layer (12).

### Admission Control Module (13)

Whenever a new station (2) enters the network, it is received in the brain layer (12) with a delay corresponding to the twinning frequency. After detection, the process of searching for an optimal configuration begins. In this process, Gₜ is converted to sₜ and given to the reinforcement learning tool. It then decides on an action to implement the agent later. This process is repeated until the decided action is to do nothing.

### Topology Extraction Module (14)

Edges are created by using detected telemetry along with θ values. For example, information about station cⱼ∈V_{c} has been collected by APi. The power (P) column in the incoming information is adapted as P_{APi}→cⱼ.

$${P}_{{AP}_{i} \to {c}_{j}} = {θ}_{{AP}_{i}} - {θ}_{{c}_{j}} + {P}_{{c}_{j} \to {AP}_{i}} \qquad ( 1 )$$

Thus, the edge e=(APi,cⱼ) with the value of, P_{AP}_{ᵢ}_{→cj} is put on the graph if P_{AP}_{ᵢ}_{<-c}_{ⱼ} is higher than a certain level when it is of interference type.

### Q-Learning-Based Transmission Power Control Agent (15)

### Network State Generation Module (16)

The network state is created using Gt and φ. The stations in the classes are expressed as C^{i,k}. Here k is the performance class. It is then determined how many stations connected to APi are exposed to interference by the APj. This is expressed as I^{i,j}.

| Performance Classes | Limits |
|---|---|
| 1 | ϕ > 40 dB |
| 2 | 40 dB > ϕ > ϕₜₕᵣₑₛₕ |
| 3 | ϕ < ϕₜₕᵣₑₛₕ |

$${s}_{t} = [ \begin{matrix}{C}_{t}^{1 , 1} & {C}_{t}^{1 , 2} & {C}_{t}^{1 , 3} & {I}_{t}^{1 , 1} & {I}_{t}^{1 , 2} & ⋯ & {I}_{t}^{1 , M} \\ {C}_{t}^{2 , 1} & {C}_{t}^{2 , 2} & {C}_{t}^{2 , 3} & {I}_{t}^{2 , 1} & {I}_{t}^{2 , 2} & ⋯ & {I}_{t}^{2 , M} \\ ⋮ & ⋮ & ⋮ & ⋮ & ⋮ & ⋱ & ⋮ \\ {C}_{t}^{M , 1} & {C}_{t}^{M , 2} & {C}_{t}^{M , 3} & {I}_{t}^{M , 1} & {I}_{t}^{M , 2} & ⋯ & {I}_{t}^{M , M}\end{matrix} ] \\ {a}_{t} = [ {AP}_{i} , θ ]$$

### Reward Function Module (17)

After each action, the reward is calculated for the state action pair. The difference between the states is used in this calculation.

$$\begin{matrix}{s}_{d} = {s}_{t + 1} - {s}_{t} = [ {C}_{t + 1} \vert {I}_{t + 1} ] - [ {C}_{t} \vert {I}_{t} ] \\ = [ {C}_{d} \vert {I}_{d} ]\end{matrix}$$

The reward calculation is done using the C_{d} νe I_{d} matrices and the reward factor. The reward factor is the mapping of desirability of change in performance classes. The reward is expressed as follows.

$$r ( {s}_{t} , {a}_{t} ) = {C}_{d} λ {U}_{c} - {U}^{T} {I}_{d} {U}_{I}$$

In this expression, U is the all-ones matrix, the size of the matrix U_{c} is 3×1, and the matrix Uᵢ is M×1.

The sum of all C_{d} values will always be 0, as the state of the network does not change during the calculation process. Reducing the number of stations (2) in the 3rd performance class is more important than increasing the 1st class since the goal is to achieve a sufficient value of φ. As such, the reward factor λ=[λ₁, λ₂, λ₃]^{T} must be selected as denoted below.

$${λ}_{3} < 0 < {λ}_{1} \vert {λ}_{1} \vert > \vert {λ}_{3}$$

In the case of performance class 2, the reward factor is set to 0 in order not to repeat the award.

### Reinforcement Learning Agent (18)

The Q table is in the following format.

$$Q : S \times A \to R$$

The update formula below is utilized after the next state arrives.

$$Q ( {s}_{t} , {a}_{t} ) = Q ( {s}_{t} , {a}_{t} ) + α [ {r}_{t} + γ {max}_{a} Q ( {s}_{t + 1} , a ) - Q ( {s}_{t} , {a}_{t} ) ]$$

α is the learning rate and γ denotes the discount factor.

1. A system that reduces the interference created by access points on devices by choosing the possibility that gives the solution that reduces the impact of the most interference in order to reduce the negative impact on performance due to the interference problem in wireless networks and dense access point positioning, by using reinforcement learning and performing a comprehensive search process, the system comprising:
a physical network that communicates with users;
a station comprising fixed or portable devices capable of using certain protocols;
an access point comprising a network hardware device that connects other Wi-Fi devices to a wired network;
an agent application that records packets detected by the access point and communicates with a controller;
a cloud comprising flexible online computing resources shared among users and scalable at any time;
wherein the controller performs all the procedures and modules in the system;
a digital twin network layer which creates an interference-based representation of the physical network layer;
a southbound interface for communication between the physical network layer and the digital twin layer;
a digital twin collection comprising digital twins;
wherein the digital twin is a realistic virtual representation of the physical entity;
a northbound interface that provides communication between the digital twin layer and a brain layer;
wherein in the brain layer applications that can run effectively on a digital twin network platform and make requests which need to be handled by the digital twin network are deployed to implement traditional or innovative network operations with low cost and less service impact on real networks;
an admission control module that decides whether procedures need to be repeated;
a topology extraction module that extracts the network topology by mapping the objects;
a Q-Learning based transmit power control agent which tries to find the tuning that reduces interference;
a network state generation module that generates network state using requirements table, performance table, and topology;
a reward function module that generates rewards by looking at the difference between network states; and
a reinforcement learning agent that updates the Q Table and determines the action according to the greedy rate.

2. A method that reduces the interference created by access points on devices by choosing the possibility that gives the solution that reduces the impact of the most interference in order to reduce the negative impact on performance due to the interference problem in wireless networks and dense access point positioning, by using reinforcement learning and performing a comprehensive search process comprising of the following process steps:
an agent application deployed on an access point sends data about stations it collects to a digital twin network layer inside a controller which resides in a cloud with a predetermined twinning frequency;
a northbound interface receives the data and updates the digital twins in a digital twin collection (1002);
transmitting a current state of the digital twin network layer to a brain layer (1003);
if it is detected that a new station has entered the network, an optimal tuning search process starts in the brain layer (1004);
extraction of the topology so that brain layer can process (1005);
a Q-Learning based transmission power control agent generates the system state with the data coming from the digital twin network layer by means of a network state generation module (1006);
after each is action applied, a reward calculation is done by the reward function module (1007);
updating the Q table in a reinforcement learning agent with the calculated reward (1008);
the reinforcement learning agent uses the concept of exploration or exploitation according to the greedy rate (1009);
random action selection in exploration concept (1010);
selecting the action that promises the least interference in the table in the concept of exploitation (1011);
application of the selected action to the digital twin network layer by the northbound interface (1012);
the digital twin network layer transmits the feedback flow to the physical layer via a southbound interface (1013); and
if the action is to “do nothing”, it is understood that the optimal solution has been reached and the process is terminated (1014).
